(19) United States
(12) Patent Application Publication
(10) Pub. No.: US 2019/0358676 A1
(43) Pub. Date: Nov. 28, 2019

(54) PNEUMATIC GRAIN SORTER

(71) Applicant: Stevia Natural S.A., Asuncion (PY)

(72) Inventors: Maridian Jose KADOMATSU HERMOSA, San Lorenzo (PY); Miguel Angel CAMPUZANO BUBLITZ, San Lorenzo (PY); Luis Ernesto ZILLICH ANTONELLI, Asuncion (PY)

(21) Appl. No.: 16/032,475

(22) Filed: Jul. 11, 2018

(30) Foreign Application Priority Data
May 25, 2018 (PY) P 1839794

(51) Int. Cl. B07B 13/05; B07B 13/11; B07B 13/14

(52) U.S. Cl. CPC B07B 13/05; B07B 13/14; B07B 13/11

(57) ABSTRACT

The invention relates to a pneumatic grain sorter comprising a conduit which has a grain inlet, a first air inlet, a second air inlet, a deflector between the first air inlet and the second air inlet coinciding with the grain inlet, such that the deflector divides the conduit into a first section and a second section, an upper outlet, and a lower outlet, wherein the grain inlet introduces grains into the conduit which are reached by an airflow introduced by the first air inlet into the second section of the conduit, and raises smaller grains to the position of the second air inlet, while larger grains are not raised and they are guided to the first section.

### CROSS REFERENCE TO RELATED APPLICATION

This application claims priority of Paraguay Application No. P 1839794 PY filed May 25, 2018, application which is incorporated herein by reference.

### FIELD OF THE INVENTION

The present invention relates to a pneumatic grain sorter that improves sorting efficiency since, given the size and design thereof, it can be incorporated into existing installations, for example, milling machines.

### BACKGROUND OF THE INVENTION

Cereal grains such as wheat and rice have grains that greatly vary in size, meaning that pre-sorting based on size distribution is necessary for a good milling yield.

In order to sort according to grain size, different methods or processes are known, among which include:
separation by means of a sieve,
sorting based on different grain densities, and
sorting by means of airflow.

Separation by means of a sieve, which separates based on the geometric shape of each grain, is not effective since there are no substantial differences between different grains. Likewise, sorting based on different grain densities is also not effective since there is little or no difference in density among grains of different sizes. However, the method for sorting by applying airflow is more versatile because it can be calibrated in a way that enables particles to be separated according to the shape and size thereof.

Another application of the airflow is for cleaning solids incorporated in a downward flow, such that the applied airflow carries particles with a much lower density and a size that is very small with respect to the solids incorporated in the downward flow. One application is thus disclosed in document U.S. Pat. No. 8,590,709 B2.

Documents U.S. Pat. Nos. 6,213,307 B1 and 5,733,592 disclose equipment for sorting by weight, density and shape, which are large, meaning that they are not suitable for installation into milling equipment, but rather, where they exist, they are placed in equipment prior to the grain storage system.

The applicant is also aware of document CN 107185837 A which discloses a sorting device that has a cyclone separator in the upper central part of a fine/light particle collector, with a primary air inlet pipe connected to one side of the separator, with a sedimentation grader at the conical bottom of the separator that continues toward the coarse particle collector, and also has a secondary air inlet pipe connected to the side of the coarse particle collector.

### DESCRIPTION OF THE INVENTION

The object of the invention is a pneumatic grain sorter comprising a conduit such that in the conduit there is a grain inlet with an entrance that is introduced inside the conduit, a first air inlet located in the conduit in a lower position with respect to the grain inlet, a second air inlet located in the conduit in a higher position with respect to the grain inlet, a deflector between the first air inlet and the second air inlet coinciding with the grain inlet, an upper outlet and a lower outlet.

The deflector divides the conduit into a first section and a second section.

In the pneumatic grain sorter object of the invention, the grain inlet is configured to introduce grains into the conduit, the first air inlet is configured to introduce airflow into the conduit, such that the airflow introduced by the first air inlet coincides with the grains in the second section of the conduit and raises smaller grains to the position of the second air inlet where they are driven towards the upper outlet, while larger grains are not raised and they are guided to the first section exiting through the lower outlet.

In the pneumatic grain sorter object of the invention, the first air inlet is tilted to achieve minimal resistance when the airflow enters inside the conduit.

In the pneumatic grain sorter object of the invention, the first air inlet is located without being centered in the conduit.

In the pneumatic grain sorter object of the invention, the upper outlet is in turn divided into an outlet for impurities and an outlet for small grains.

The pneumatic grain sorter object of the invention comprises an elbow between the upper outlet and the conduit, the outlet for impurities being located in the geometric extension of the elbow and the outlet for small grains being located under the outlet for impurities.

### BRIEF DESCRIPTION OF THE DRAWINGS

A very brief description of a series of drawings that aid in better understanding the invention, and which are expressly related to an embodiment of said invention that is presented by way of a non-limiting example of the same, is provided below.

FIG. 1 shows a schematic view of a side cross section of the sorter object of the invention.

FIG. 2 shows a schematic view of the sorter object of the invention showing the interaction of the deflector, the grain inlet and the first air inlet from the upper part thereof.

FIG. 3 shows a schematic side view of the grain inlet, the first air inlet and the second air inlet to the conduit of the sorter object of the invention.

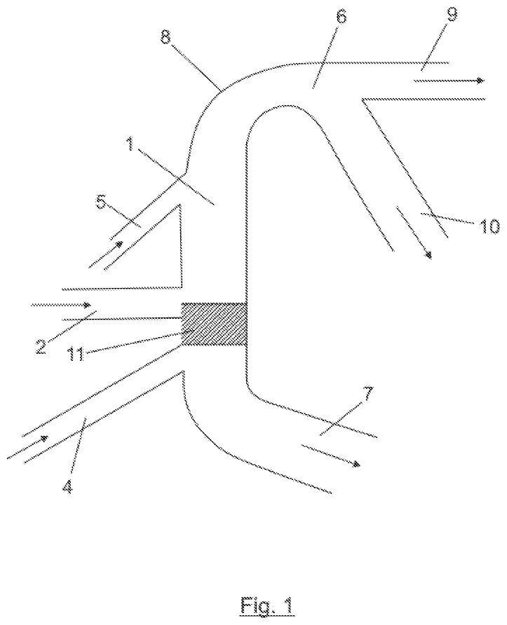

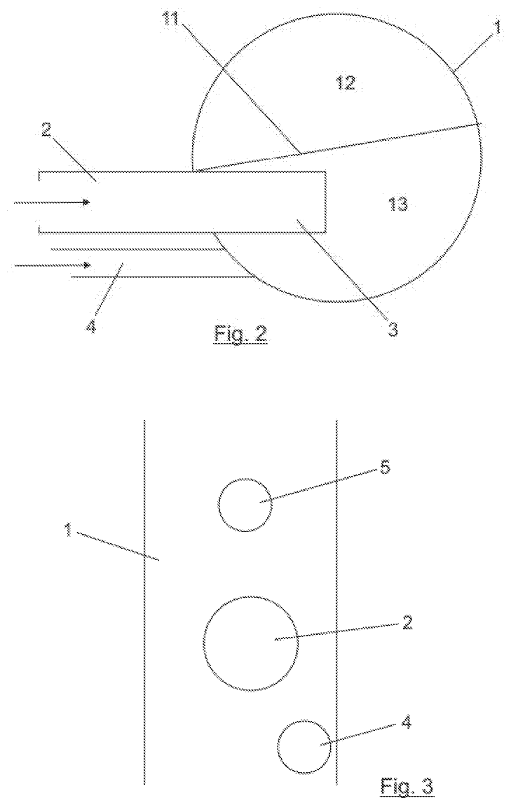

A list of the elements and the numerical references associated with them, which are used in the figures, is shown below:

1. conduit,

2. grain inlet,

3. entrance,

4. first air inlet,

5. second air inlet,

6. upper outlet,

7. lower outlet,

8. elbow,

9. outlet for impurities,

10. outlet for small grains,

11. deflector,

12. first section, and

13. second section.

### DETAILED DESCRIPTION OF THE INVENTION

The object of the invention is a pneumatic grain sorter comprising a conduit (1) which has a grain inlet (2), which is introduced inside the conduit (1) by means of an entrance (3).

The entrance (3) reduces the thickness with which the grains are introduced into the conduit (1).

The sorter object of the invention comprises:
a first air inlet (4) located in the conduit (1) in a lower position with respect to the grain inlet (2),
a second air inlet (5) located in the conduit (1) in a higher position with respect to the grain inlet (2).

The conduit (1) has an upper outlet (6) and a lower outlet (7), the upper outlet (6) being connected to the conduit (1) by means of an elbow (8). Furthermore, the upper outlet (6) is in turn divided into an outlet for impurities (9) and an outlet for small grains (10), the outlet for impurities (9) being located in the geometric extension of the elbow (8) and the outlet for small grains (10) being located under the outlet for impurities (9).

The first air inlet (4) is tilted such that minimal resistance is achieved when the airflow enters inside the conduit (1).

The airflow that enters through the first air inlet (4) guides the smaller grains to a height such that they reach the position of the second air inlet (5), where the airflow that passes to the conduit through the second air inlet (5) pushes the smaller grains towards the upper outlet (6).

The airflow that enters into the conduit through the second air inlet (5) is guided toward the upper outlet (6) and the fact that the outlet for impurities (9) is in geometric continuity with the elbow (8) means that the impurities exit, pushed by the airflow from the second air inlet (5) through the outlet for impurities (9), and the small grains do not reach said outlet for impurities (9) and exit by gravity through the outlet for small grains (10).

Inside the conduit (1) located between the first air inlet (4) and the grain inlet (2), the pneumatic grain sorter object of the invention comprises a deflector (11) that divides the inside of the conduit into a first section (12) and a second section (13), such that the grains to be sorted are introduced into the conduit (1) in the first section (12) which in turn is the section that receives the airflow that enters through the first air inlet (4).

The deflector (11) in turn requires the airflow that enters into the conduit through the first air inlet (4) to take the path of contact with the grain inlet (2).

Thus, when the grains are introduced into the conduit (1) by means of the grain inlet (2), they receive the airflow from the first air inlet (4) through the second section (13) of the deflector, such that the airflow raises the smaller grains and makes the larger grains fall through the first section (12) of the deflector (11) until reaching the lower outlet (7) of the device, without once again receiving the airflow from the first air inlet (4).

The first air inlet (4) is located without being centered in the conduit (1), such that the airflow does not rise vertically, but rather with a slight rotation, which provides improved carrying of the grains. Furthermore, the rotational movement allows the larger grains to be guided in the direction of the first section (12), where, as discussed above, they exit through the lower outlet without once again interacting with the airflow from the first air inlet (4).

1. A pneumatic grin sorter comprising a conduit which has:
a grain inlet with an entrance that is introduced inside the conduit;
a first air inlet located in the conduit in a lower position with respect to the grain inlet;
a second air inlet located in the conduit in a higher position with respect to the grain inlet;
a deflector between the first air inlet and the second air inlet coinciding with the grain inlet, such that the deflector divides the conduit into a first section and a second section;
an upper outlet; and
a lower outlet;
such that the grain inlet is configured to introduce grains into the conduit, the first air inlet is configured to introduce airflow into the conduit, such that the airflow introduced by the first air inlet coincides with the grains in the second section of the conduit and raises smaller grains to the position of the second air inlet where they are driven towards the upper outlet, while larger grains are not raised and they are guided to the first section exiting through the lower outlet.

2. The pneumatic grain sorter according to claim 1, wherein the first air inlet is tilted to achieve minimal resistance when the airflow enters inside the conduit.

3. The pneumatic grain sorter according to claim 1, wherein the first air inlet is located without being centered in the conduit.

4. The pneumatic grain sorter according to claim 1, wherein the upper outlet is in turn divided into an outlet for impurities and an outlet for small grains.

5. The pneumatic grain sorter according to claim 4, further comprising an elbow between the upper outlet and the conduit, such that the outlet for impurities is a geometric extension of the elbow and the outlet for small grains is located under the outlet for impurities.
